(19) United States
(12) Patent Application Publication
(10) Pub. No.: US 2005/0278210 A1
(43) Pub. Date: Dec. 15, 2005

(54) Computerised planning system and method for sales to clients in the hospitality, travel and leisure industries

(76) Inventors: Simon Roberts, Teddington (GB); Michael Prager, Bourne End (GB); Mark Hardman, Reading (GB)

Correspondence Address: STITES & HARBISON PLLC, 1199 NORTH FAIRFAX STREET, SUITE 900, ALEXANDRIA, VA, 22314, US

(21) Appl. No.: 10/863,527

(22) Filed: Jun. 9, 2004

(51) Int. Cl. G06F 17/60

(52) U.S. Cl. 705/10

(57) ABSTRACT

A computerised system and method for planning sales to clients in the hospitality, travel and leisure industries, by a sales team of at least one salesperson, comprising database software enabling or method steps of input and display of client data for each client; allocation of client data for each client to a responsible salesperson; and input and display of sales planning data for each client according to an overall business plan so that each salesperson can apportion sales time to each client according to the business plan.

### FIELD OF THE INVENTION

The present invention relates to a system and method for planning sales activity, particularly in the hospitality, travel and leisure industries. The invention is especially useful in planning sales team and activities to achieve goals in line with those of an overall business plan.

### BACKGROUND OF THE INVENTION

The last half of the twentieth century, and in particular the last two decades, have been characterised by a rapid change in the travel industry, particularly the hospitality segment of that industry. Hotels and motels have been driven by scale economies and a desire to utilise brand loyalty among travellers to evolve from smaller isolated operations to a preponderance of large chains of hotels and/or motels operating under a common name. With this evolution, sales has become an increasingly important part of the business. This expansion has also led to the development of industry specialised software for management of hotels, known as PMS or Property Management Systems. These provide reservation and accounting transactions as well as statistical information on guest history data for example, and downstream systems such as occupancy of dining and other areas. In addition to this RMS (revenue management systems) or CRM (customer relationship management) have been developed which can interface with a central reservation system or CRS.

Sales activity, which is directed more generally to corporate clients, can be an accurate predictor of revenue (also sometimes known as production). In this industry, buying decisions by corporate entities are often separated from booking decisions. For example, a company might buy a number of rooms in a hotel, or seats on flights in bulk at a negotiated price, but book the actual dates for the occupancy at a later point in time. Thus contracts are made on a “futures” basis and the buying decision is separated from the booking decision. Sales activity may aim to maximise revenue by negotiating higher prices and/or higher occupancy. However, the maximum occupancy (at least in the short term) is limited by the number of rooms/seats available. In other words, this industry is a fixed inventory supply and variable demand model; sales optimisation has an important role to play. Moreover, the supply may be underused at certain times (for example at weekends in business hotels) and oversubscribed at others. Clearly, the sales strategy can be complex in this situation and systems are required to aid the sales team.

Computerised aids for Sales Teams or Sales Force Automation (SFA) has been around for ten years or more. Sales Force Automation (SFA) takes the traditional manual procedures that make up the sales process, such as creating lists of target clients, creating and filing call reports, recording sales volume etc. from a paper based to a computer based environment. In so doing, early SFA tools brought word processing, data processing and business rules together into one package. Initially SFA tools were all generic, such as ACT, Goldmine and Siebel. Latterly, however, industry sector, specialist models that used the terminology and accounting practices of specific industry groups were developed. In the hotel sector these were pioneered by Fidelio (MicrosFidelio Inc.) & Delphi (Newmarket Inc) or although there are now others.

Practitioners in the industry found that these systems had certain shortcomings from a user perspective. Namely,
SFA tools were largely reactive, they did not allow considerations of goals and objectives from other budgeting tools in the organisation, they simply recorded what was done.
There was a bias towards forecasting results of actions/initiatives as opposed to a logical linkage of results as the outcome of actions/initiatives.
Business Rules were generated in a way that was easy for the system rather than tightly applied to the real situation and planning techniques of the sales team and consequently did not work well or were largely ignored.

Since these prior art SFA programs are not sufficiently linked to the business objectives in each situation, they were not well adapted for planning sales or to motivate sales teams and render them accountable.

There is thus a need for better support for management of sales activities within the hospitality, travel and leisure industry.

### SUMMARY OF THE INVENTION

According to one aspect, the present invention provides a computerised system for planning sales to clients in the hospitality, travel and leisure industries, by a sales team of at least one salesperson, comprising database software enabling input and display of client data for each client; allocation of client data for each client to a unique salesperson; and input and display of sales planning data for each client according to an overall business plan so that each salesperson can apportion sales time to clients according to the business plan.

In an equivalent method aspect of the present invention, there is provided a computerised method for sales to clients in the hospitality, travel and leisure industries, by a sales team of at least one salesperson comprising the following method steps: input and display of client data for each client; allocation of client data for each client to a unique salesperson; input and display of sales planning data for each client according to an overall business plan and individual apportioning of a salesperson's sales time to clients according to the business plan.

Reference herein to a business plan includes a plan indicating resource availability and strategic goals for the sales team, probably as a component of a hotel's or other organisation's business plan. Reference herein to database software includes a database (or a set of linked databases) and programming code.

Embodiments of the invention allow future sales figures to be planned with reference to the business plan which is created at a higher level within the hotel or other organisation structure and which usually defines budget for sales per specific market segment. Furthermore, since the system is a “bottom-up” design, the system is completely configurable to changes in the organisation size and/or shape. Business rules remain constant event if the consolidation of data by sales person changes. Importantly, sales time and resources can be scheduled with respect to sales planning data so that sales efforts and targets are logically linked.

An underlying philosophy of the invention is that the business decides and the technology enables, not vice versa. Therefore the business rules (standard procedures) within the system that are dictated by best practice, accepted custom and practice or accounting standards are inbuilt to the invention. Business rules remain constant e.g. production must always be a function of potential, never the other way around, even if the way in which the organisation groups and consolidates its management data changes as it reshapes and resizes. The bigger issue of the bottom-up design is that this provides an added dimension to the budgeting process which is almost always a top down approach along the lines of “we did this much last year so we want this much plus x percent next year”. Where the bottom-up and top down totals come together they rarely, if ever, meet at the first pass and this is where the value from using embodiments of the method and system is unlocked, because the bottom-up figures are created using the business plan.

According to a further aspect of the present invention there is provided a computerised system for planning sales to clients in the hospitality, travel and leisure industries, by a sales team of at least one salesperson, comprising database software enabling input and display of client data for each client; allocation of client data for each client to a responsible salesperson; and input and display of sales planning data for each client in terms of past and future sales figures for each client; and input and display of activities for the salesperson to achieve the future sales figures.

In an equivalent method aspect there is provided a computerised method for planning sales to clients in the hospitality, travel and leisure industries, by a sales team of at least one salesperson, comprising method steps of input and display of client data for each client; allocation of client data for each client to a unique salesperson; input and display of sales planning data in terms of past and future sales figures for each client; and input and display of activities for the salesperson to achieve the future sales figures.

Embodiments of the invention allow sales activities to be based on relevant data specific to the client, this data also permitting detailed analysis of growth, profitability, strategic fit and contribution from each client.

Preferably, the database software also enables input and display of sales time on a calendar. Thus the user can use the same system both to identify sales effort required for a specific client using past and future sales figures and to diarise planning activities in the sales effort.

The database user interface (or front end) is preferably set up to provide a set of screens (or forms or dialogue boxes) accessible by tabs or any other convenient method from a header screen (main menu). However, other viewing and input formats are not excluded. For ease of reference, screens are referred to in the following where means of input and display are intended, but the reader will appreciate that this term includes other suitable input and display formats.

A client data screen preferably includes the responsible salesperson, the client's name and contact details and any account/client code specified for the client, and more preferably, a list of contact persons within the client organisation. The client data also include a client priority according to the revenue they are budgeted to generate, allocated by the sales team. This allows instant recognition of a client's importance to the business when their details are viewed. For example, each client may be classified as a key client, a key prospect, a niche client or a suspect.

There may be a distinction between active and inactive clients in the client data, to distinguish between clients who are actively targeted (for example still in business) and those who are not. Furthermore, the client data may include an indicator as to whether the client is part of a larger parent company.

The planning data relates to sales. Preferably, the planning data includes sales figures by financial year, specifically for the present financial year (for example in the form of forecast figures and/or this year's plan) and actual sales figures for the last financial year and/or planned sales figures for the next financial year. More preferably, the planning data includes a logical model that builds sales figures indicating the complete potential of the client per year in the competitive set of the hotel or other business (e.g. airline) to indicate the client size for benchmarking and comparison purposes. For simplicity, the term “year” used hereinafter refers to the financial year of the sales office which is set as part of the system installation.

In one advantageous embodiment, the client potential, actual sales figures for last year and forecast for this year may be input and displayed in a sales data screen. These figures may then be exported to other screens.

The planning data may express sales in one or more ways, such as revenue generated by a client for accommodation including or excluding extras, or in terms of number of room nights and/or number of and revenue from covers and/or extras or any other suitable measure. These terms refer to an embodiment used in a hotel, but the concepts apply equally to other businesses in this sector. For example, if the system is implemented by an airline, the “accommodation” refers to flights and “room nights” are “seats”. There may be subdivisions by market segment according to the class of seat (business, economy etc).

Preferably, sales figures are expressed in revenue and room nights for accommodation allowing calculation and display of the average room rate or ARR (revenue divided by room nights). The ARR is preferably calculated by the system from revenue and room nights, both of which may be inputted directly or imported from one or more external systems as appropriate. Catering may additionally be expressed in covers and revenue (which may be input manually) with automatic calculation of the average check (average catering revenue cost per cover).

The planning data may be sub-divided into general market segments, such as individual rooms, group & crew rooms and covers (one cover is a meal for one person). These market segment figures may be summed and/or averaged automatically by the system, for example to produce total room figures and total covers and rooms figures. Further specific sub-divisions and automatic totals are also available.

Preferably, there is provided a segment targets screen for input and display of revenue data according to specific market segments. Advantageously, the subdivision of the market-segments is that of the business plan, so that direct comparison between the budget allocated to the specific segment in the business plan and planned sales is made possible.

Preferably, there are provided sub-totals on the segment targets screen corresponding to the general market segments of the sales data screen. Once the target segment screen is completed (for example by manual input) the data may be exported to the appropriate categories for the plan year in a sales summary screen. The client potential, actual sales figures for last year, forecast for this year and plan for next year may be displayed on the sales summary screen.

This progression of data entry and display from entry of data from the past, to plan for the future, and then display of the two on a single screen, potentially together with all variances, in values and/or percentages is a valuable tool for the salesperson and formalises the mental planning process often used in this field. The variances may show the differences between the plan and the forecast and the percentages may refer to the actual, forecast and planned share of potential.

In one advantageous embodiment, the sales summary screen and/or sales data screen may display a table with a row pair for each financial year required (potential, actual last year and forecast this year for the sales data) subdivided by general market segment (for example in columns). Further columns may be used for average room rate (ARR), average check and totals. In the row pair, one row gives the number of room nights and the other revenue. Additionally, number of covers is shown on one row and revenue for covers on the other.

The database software may include a calendar screen which is specific to each client and to each user (e.g. salesperson or administrator). Preferably, calendar data is entered under one of two main headings: events (dates and descriptions which are pre-set such as conferences); and activities (dates and descriptions which are planned by the sales team such as client meetings and reviews). Advantageously, the events and activities can be easily distinguished on a standard calendar overview screen and there is functionality to alert when the user prevent an activity is being scheduled at the same time that an event is already entered.

Preferably, the calendar may also be displayed in matrix form in an activities screen, including a table listing activities or events in rows, the months being displayed in columns across the screen and the entry in each cell giving the date in the month. More preferably, two tables are displayable, one for events and one for activities. The calendar allows an overview of each salesperson's time. Previously, it was possible to measure results only, rather than actions and initiatives. Embodiments of the present invention allows easy comparison and a stimulus: response view of of activities and the plan data.

The database may have additional functionality for the production of reports and diagnostics which allow interrogation of various scenarios for each individual client and the entire client portfolio.

The database software is preferably implemented in the form of an application running on one or more computers and a database held on that computer or (more commonly) on a server. Data may be exported and imported automatically to and from other systems (such as the PMS, CRM or SFA systems or Microsoft Outlook, for the calendar data) and/or input manually. The database itself may be implemented in Microsoft Access and the user interface in Microsoft Dotnet. Thus the application is menu driven, with drop-down menus and the usual navigation possibilities.

### BRIEF DESCRIPTION OF THE DRAWINGS

FIG. 1 is a screen print of a client list screen according to an embodiment of the invention;

FIG. 2 is a screen print of a Client Details screen according to an embodiment of the invention;

FIG. 3 is a screen print of a Sales Data screen according to an embodiment of the invention;

FIG. 4 is a screen print of a Segment Targets screen according to an embodiment of the invention;

FIG. 5 is a screen print of a Plan (Sales Summary) screen according to an embodiment of the invention;

FIG. 6 is a screen print of an Activities screen according to an embodiment of the invention;

FIG. 7 is a drop down panel for adding a client activity according to an embodiment of the invention;

FIG. 8 is a drop down panel for adding a new client activity type according to an embodiment of the invention;

FIG. 9 is a drop down panel for adding an event according to an embodiment of the invention;

FIG. 10 is a drop down panel for adding a new type of event according to an embodiment of the invention;

FIG. 11 is a screen print of an Activities (Calendar View) screen according to an embodiment of the invention;

FIG. 12 is a flow diagram of a method for adding sales data and planned activities to achieve planned sales figures to a computerised system according to an embodiment of the invention;

### DETAILED DESCRIPTION OF THE INVENTION

The present invention is a method and system for decision support/executive planning in the hospitality, travel and leisure industries. In one embodiment the present invention (or Sales Optimiser) is provided as a software tool that will function in the planning & scheduling stage of the sales process. A version of the Sales Optimiser is implemented in Microsoft Access.

The embodiments of the present invention provide a planning tool, to be used, for example, in a hotel sales office in the planning and scheduling phase. It allows sales staff to focus on the best options for the clients they want to progress and concentrate on.

A fundamental part of the philosophy of this system is that planning is “bottom up”. This means that plans will be entered at the lowest level only, i.e. for one sales person dealing with one client. In a typical sales centre there will be 100 to 200 clients per user. In a typical sales centre there will be 500 to 600 clients in total. In a very small number of huge sales centres, there will be 1000 to 1500 clients.

Embodiments of the present invention provide a number of screens (forms or dialogue boxes) for data entry and display that are specially adapted to the requirements of sales planning in the relevant industries. These include; a main menu, client list, client details, sales data, segment targets, plan (sales summary) and activities (or calendar). They are discussed in turn below. Reports may also be provided as required, but are not addressed further in any detail.

Main Menu

Each user has a log in identity and the system defaults on entry to the main menu (not shown), from which a client list screen can be selected.

The main menu provides a selection between Client Files, Reports and Diagnostics and System Administration (maintenance and housekeeping functions). These two latter parts of the system are not considered in detail in the present application.

The client list is an alphabetic listing of all of the clients entered by the client name. Client City, Client Priority and Client Code are visible, and clients can be sorted by clicking any of the column headings. The user can either scroll down to find a specific client or enter a name e.g. ‘American Express’ or partial name e.g. ‘Amer’ in the search box. Searching by client code is also possible. To add a new client the user clicks on ‘Add New Client’. To delete a client, whilst in the client list view, there is a user prompt to ask if you ‘really want’ to delete this client. (Client files cannot be restored after being deleted). To open a client file the user either clicks on the ‘Read Client File’ button or double clicks on the highlighted client itself.

Client List

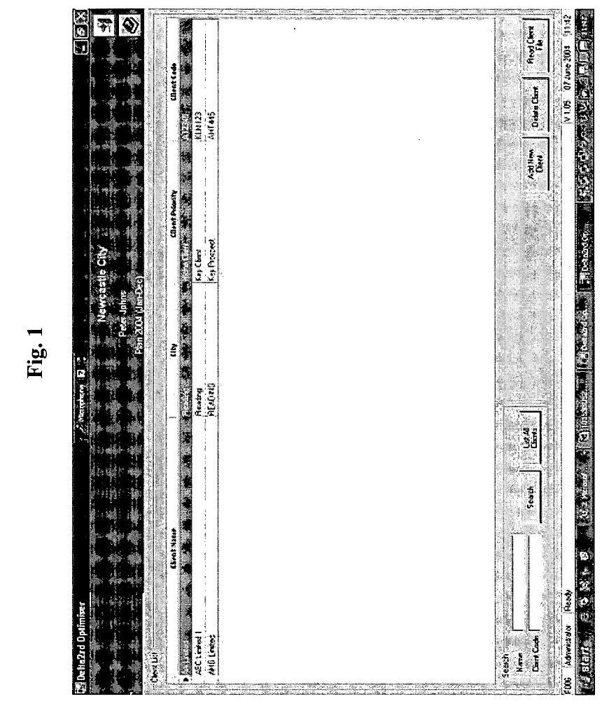

FIG. 1 shows a header screen for the client file area which is set up as a client list. The system allows the user to find a client by their name or client code. The client list is sortable by name, client city, client priority or client code. Once a particular client is chosen, the system will go to a set of tabbed screens (discussed below).

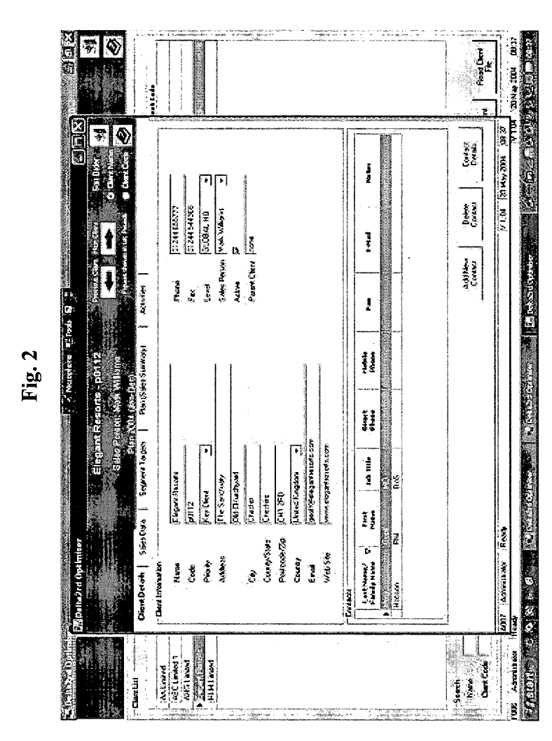

This screen allows creation of a new client and update/delete of existing client details as well as simple selection of a client. This last step selects a new view with tabbed screens as shown in FIG. 2.

Client Details

FIG. 2 shows a client file with the screen (or tab) showing client details opened.

The client details tab is where the basic name, address & contact data is input and stored for each client. The address is broken out line by line to allow for different postal system formats around the world. Priority indicates the client type by the application of the user's business rules to each client. Thus, for example, according to one set of business rules, key clients are those clients whose business combined accounts for the 70-80% of revenue that typically comes from the 20-30% of largest clients. Key Prospects are clients whose potential is the same or greater than the smallest key client but who produce small amounts only and for which there is a plan to grow their performance to key client status. Niche clients are all other buying clients. Suspects are those clients the user ‘suspects’ to have business but for which a potential analysis has not yet been completed.

The level drop down box indicates the position of the client within the company hierarchy. (Unit, Branch, Region, or Global Headquarters).

In the event of a particular sales person leaving, then an administrator will be able to go into the user profile for the sales person who has left, and over key their forename and surname and salesperson code with the details of the replacement sales person.

Alternatively (eg a sales person leaves, and is not replaced, and their clients are “shared out” between other existing sales people), the administrator will be able to go into the Client Details tab for each client and simply re-assign to another sales person by clicking the “Salesperson” drop down.

“Active” clients are clients who are, in a sense, “Live”, and the sales office wants to maintain/enhance a relationship with them. “In-Active” clients are those who are not relevant to target setting, for example, they may have gone out of business. The “Rules” for In-Active clients are as follows:

| Area | Rules |
|---|---|
| Client File and planning | still have their planning data |
| data | held on the system (for |
| | reference purposes). The operator |
| | would theoretically be |
| | able to change this information |
| | (though there would be no point). |
| Client “Profile” report | Still Print-able |
| Any other reports/ | In terms of any other reports |
| mechanisms | which analyse, compare, or |
| | aggregate client data, inactive |
| | clients would simply be |
| | totally ignored (as if they |
| | didn't exist). |

FIG. 2 also shows a simple view of multiple contacts, which belong to the relevant client. These contact records essentially act as a note pad for the relevant people who belong to a client company. No links exist from these contacts into other areas of the system.

Sales Data

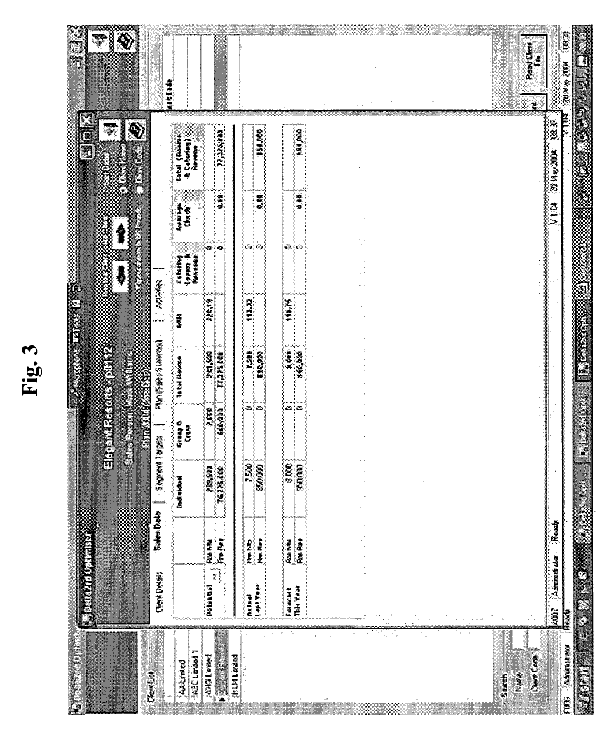

FIG. 3 shows sales data for a single client. This screen has a “block” or sub-table of three simple row pairs: Potential/Actual/Last year. Each row pair is divided by columns showing market segment as explained previously. It should be noted that total Revenue to a hotel would include telephone revenue, and other sources, which is why “Rooms & Catering” is shown as a qualifier for the total.

The Sales Data tab is for input of prior year actual production and current year forecast production. (The forecast is expected production figures at year end. This will always comprise an amount of ‘year to date actual’ and ‘remaining year forecast’). The plan is broken out into room nights and revenue, split into individual and group & crew. Both room nights and revenue must be populated at all times but there is no need to complete both individual and group & crew columns if there is (forecast) business from only one of these sectors.

The potential row requires an estimate of the total amount of business that each client has for all hotels in the competitive set. By clicking on the ‘Potential’ icon, a potential analysis calculator will open up.

The Catering section relates to non-restaurant food and beverage operations, where there is planned sales activity, e.g. a client that books meetings and events. (In some areas referred to as conference & banqueting, meeting etc). Information is entered by ‘the number of covers’ and catering revenue.

Segment Targets

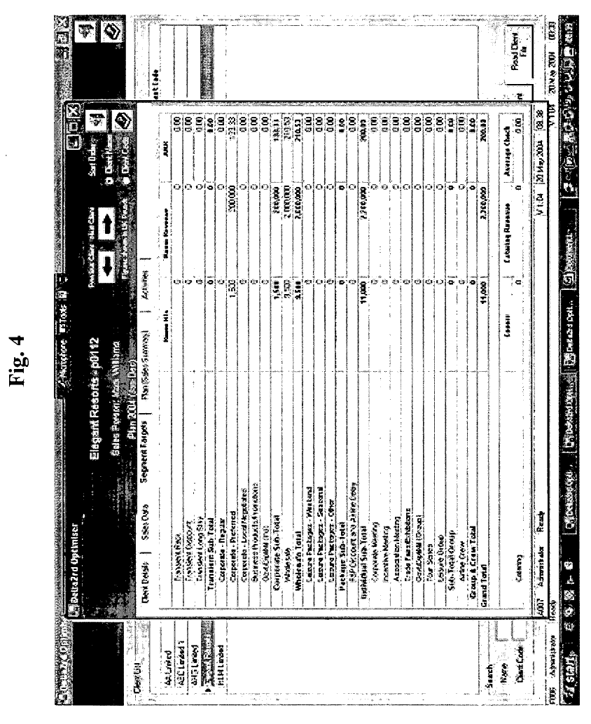

FIG. 4 shows the specific segment targets screen for a single client covering the financial year of 2004 (January-December). This plan shows a more complete breakdown by specific market segment than the general individual/group and crew type breakdown illustrated in the sales data screen.

The Segment Target tab client plan builds a plan by each market segment. The segments in this toolkit are supplied to be identical to those in the business plan to allow comparison of what is being created by sales efforts with the budget stated in the business plan. Room nights and room revenues are entered by market segment; the ARR will calculate in each case. Covers and catering revenue, entry allows automatic calculation of the average check. Different sales scenarios can be explored by changing the numbers as required. The Plan Total number will export to the ‘Sales Plan’ tab.

The following table shows a table of a breakdown to indicate data entry and calculation.

| | | Room | | |
|---|---|---|---|---|
| Field | Room Nts | Revenue | ARR | (Comments) |
| Premium | DE | DE | CALC | 1 |
| Premium Discount | DE | DE | CALC | 2 (Renamed |
| | | | | from |
| | | | | Premium |
| | | | | Direct) |
| Total Premium | CALC | CALC | CALC | 3 (1 + 2) |
| Corporate Regular | DE | DE | CALC | 4 |
| Corporate Preferred | DE | DE | CALC | 5 |
| Corporate Negotiated | DE | DE | CALC | 6 |
| Corporate Travel Agents | DE | DE | CALC | 7 |
| Total Corporate | CALC | CALC | CALC | 8 (4 + 5 + |
| | | | | 6 + 7) |
| Wholesale | DE | DE | CALC | 9 |
| Tour Series | DE | DE | CALC | 10 |
| Total Wholesale | CALC | CALC | CALC | 11 (9 + 10) |
| Leisure Packages | DE | DE | CALC | 12 |
| Weekend | | | | |
| Leisure Packages | DE | DE | CALC | 13 |
| Seasonal | | | | |
| Leisure Packages Other | DE | DE | CALC | 14 |
| Total Packages | CALC | CALC | CALC | 15 (12 + |
| | | | | 13 + 14) |
| Airline (Non Crew) | DE | DE | CALC | 16 |
| Total Airline (Non Crew) | CALC | CALC | CALC | 17 (=16) |
| Individual Sub-Total | CALC | CALC | CALC | 18 (Sum of |
| | | | | all above i.e. |
| | | | | 3 + 8 + 11 + |
| | | | | 15 + 17) |
| Corporate Meeting | DE | DE | CALC | 19 |
| Incentive | DE | DE | CALC | 20 |
| Association Meeting | DE | DE | CALC | 21 |
| Trade Fairs/Exhibitions | DE | DE | CALC | 22 |
| Govt/Dipl/Mil Group | DE | DE | CALC | 23 |
| Leisure Group | DE | DE | CALC | 24 |
| Sub-Total Group | CALC | CALC | CALC | 25 (Sum of |
| | | | | 19 to 24) |
| LongStay Aircrew | DE | DE | CALC | 26 |
| Air Crew | DE | DE | CALC | 27 |
| Sub Total Air Crew | CALC | CALC | CALC | 28 (26 + 27) |
| Group & Crew Sub Total | CALC | CALC | CALC | 29 (25 + 28) |
| Plan total | DE | DE | CALC | 30 (18 + 29) |
| | | Catering | Avg | |
| | Covers | Revenue | Chq | |
| Catering | DE | DE | CALC | 31 |

The Data Entry cells are defined as those cells where the user can actually over key (input) a number. All other cells are calculated (eg a sub-total, or a percentage). The screen adopt the display standard of all data entry cells with a white background, and all calculated cells with a yellow background. For clarity the data entry cells are shown with a “DE” symbol above, the calculated cells are shown with a “CALC” symbol above

The reader will note that there are multiple levels of totalling. There are several sub-totals which add up the “base” figures, but also “Individual Sub-Total” and “Group & Crew Sub Total” are totals of lower level sub totals. Finally, “Plan Total” is a total of (“Individual Sub-Total” and “Group & Crew Sub Total”)

There are actually three general categories above these specific segments, which are Individual Sub Total; Group&Crew Sub Total; and Catering Covers and Catering Revenue (which is separate), as shown in the sales data and plan (sales summary) screens.

Market Segment Handling

The market segment headings are often subject to different terminology in different hotel groups. To account for this, the system stores headings for the various market segments for the relevant implementation as a table with the following structure:

| | |
|---|---|
| Generic Heading | This is the heading which is known generically |
| | across the industry |
| Implementation Heading | This is the hotel's “version” of the above |
| | heading (if different) |

Some examples are shown below:

| | Implementation |
|---|---|
| Generic Heading | Heading |
| . | |
| . | |
| . | |
| Leisure Packages | Weekend Breaks |
| Weekend | |
| Leisure Packages | Seasonal Breaks |
| Seasonal | |
| Leisure Packages | Other Breaks |
| Other | |
| Total Packages | Total Leisure Break |

Plan (Sales Summary)

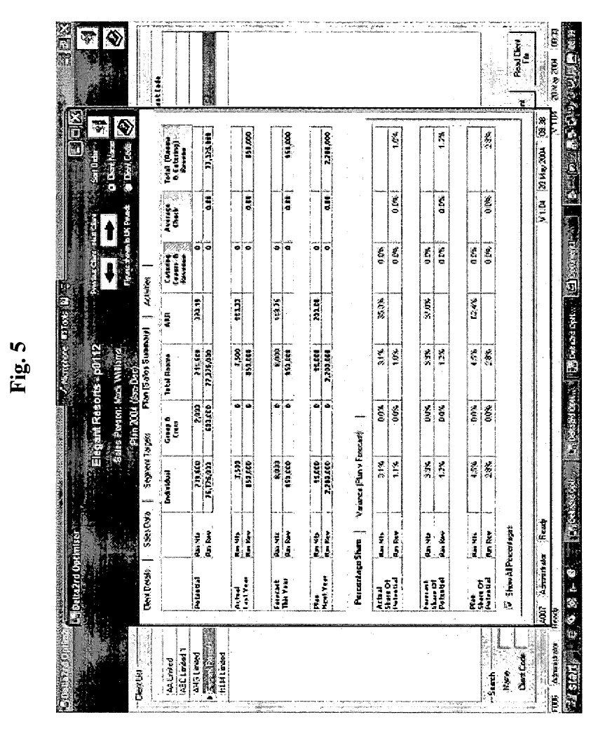

FIG. 5 shows the plan (sales summary) screen for a single client. The first four row parts give data for potential, actual last year, forecast this year and plan next year as explained previously.

Thus, this screen tab has the same three row “pairs” as Sales data. It also has a fourth row pair “plan year”. This is derived directly from the market segment data, entered on the previous tab.

The Plan (Sales Summary) tab requires no user input. It is a summary of the prior and current year data entered in the ‘Sales Data’ tab and the plan year data entered in the ‘Segment Target’ tab.

The percentage share window displays the percent of potential (or share) captured each year. The default display gives percentages for only total rooms to make it easier to read. The variance tab displays both values and percentages to show both the amount that the client room nights, covers and revenues are changing year on year and the percent which that represents.

The lower part of the screen is a percentage share section. It consists of an area with two tabs on it. Percentages and “Variance”. (The “Percentages” tab is shown by default.

Activities—Matrix View

The Activity Tab is for input of events and of critical or strategic sales activities to meet the client specific room night and revenue (and covers) targets. Activities can be planned and viewed in either an activity or a calendar view.

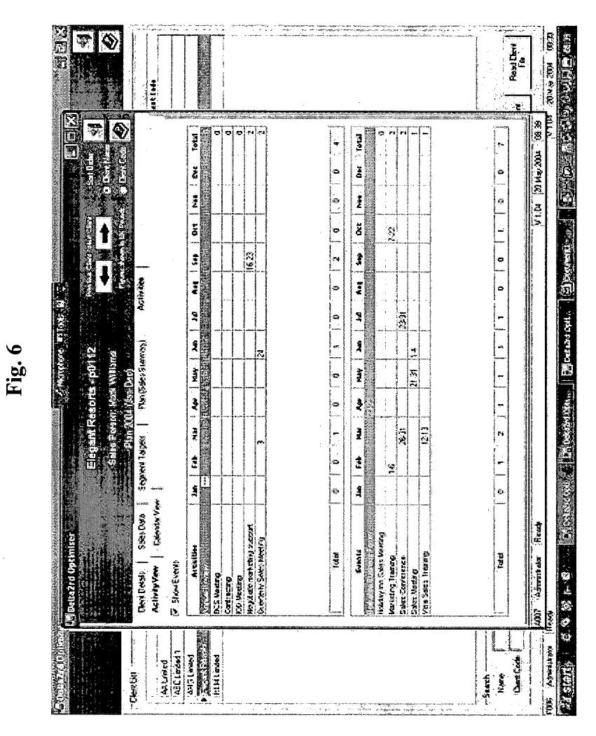

FIG. 6 shows an activities view. The events are a set of dates and descriptions which the sales office needs to know about (eg sales conferences etc), to avoid sales people double booking. They can only be added by an administrator. Events are shown in the activity view as a separate window that can open or close by ticking of the ‘show events’ box and in the calendar view as a tape chart on the diary. To view the event itself the cursor is held over the tape and a comment box will open with the event title in it (the same applies to an activity in the calendar view).

In general, planned activities are strategic in nature, i.e. ‘must do’ tasks that drive the business forward towards planned production levels. A generic list of the sort of activities this represents includes, for example: provide or receive information (including conducting potential analyses); review or agree performance levels; negotiate new business and broaden the contact surface between client and hotel sales team. Activity headings should be short, to the point and specific. Lunch, for example, is not an activity, it is a method by which a business activity is carried out and therefore should not be planned.

It is not possible to accurately plan activities with clients months out so this feature gives a ‘waypoint’ list of things that must be done in order to meet the planned results from that client. If the actual date is not exactly when planned that does not matter. However, it is important that if there is a change to what is planned it is done with forethought and for a good reason and not just forgotten or overlooked. The activity planner helps the salesperson remain focused on the main remit of the job, meeting and dealing with clients. Whether in the calendar view or the activity view, the activity box will always pop up a monthly calendar. Once fully populated for all key clients and key prospects, only key clients and key prospects need be diarised to this degree and this will form the backbone of the salesperson's personal planning calendar. The calendar may export to Outlook or any other sales management tool diary.

An important and useful feature is a calendar bubble, which allows the operator to move their mouse over the date on any “calendar representation”, to show via a yellow “bubble” any activities and/or events which fall on that day.

The Activities and Events functionality is driven via a dual tab view. The two tabs are “Activity View” (the default tab), and “Calendar View”. The activity view shown in FIG. 6 is a matrix type representation which will depict the dates of activities and events in a set of column headings (determined by the “First Planning Month” setting).

If the user ticks the tick box “Show events” then the events will be shown in a separate panel at the bottom of the screen. The activity part shows the relevant dates in the top part, together with totals down the side and along the bottom. The events part also has totals. (In all cases, the totals are for the number of activities/events rather than the number of days. (Events can span more than one day).

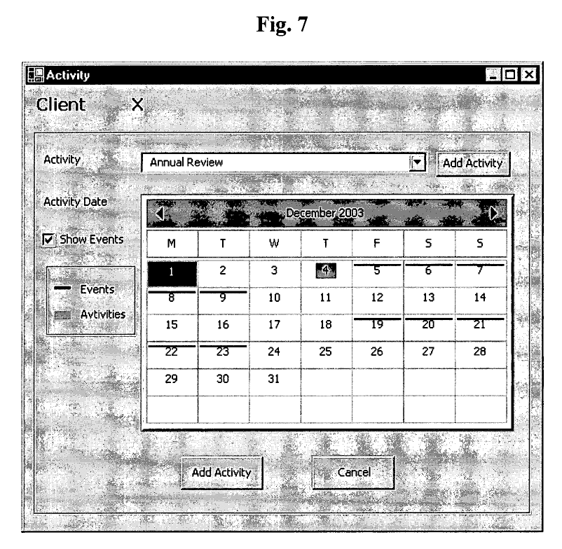

The user can add activities directly from the user interface, by clicking in a particular cell. For example, if the user clicks in the cell where “Annual Review” and ” Dec” (December) intersect, they are presented with the panel shown in FIG. 7.

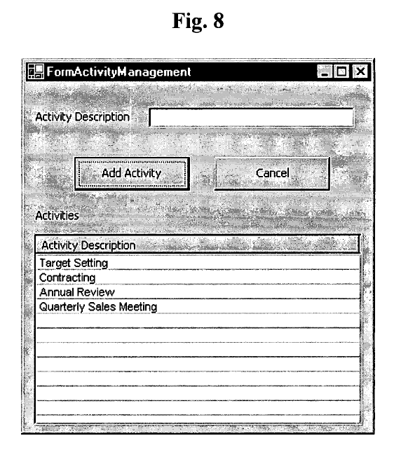

Regardless of whether the tick box “Show Events” is ticked, any attempt to book an activity on the same day as an event results in a warning box “you are adding an activity on <date> which clashes with <event name> <event location>, are you sure you want to proceed?” YES/NO. As well as being able to choose from the “standard” activities, the operator can add activities, via the “Add Activity” button just to the right of the Activity drop-down. When the user clicks this button, they will be presented with a simple pop-up, which allows them to add new activity headings. FIG. 8 shows such a pop-up.

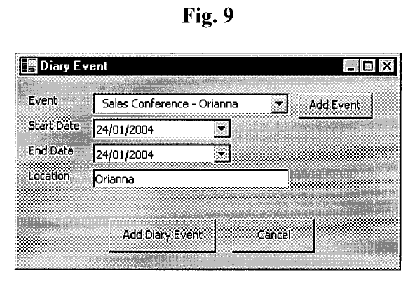

Events need an optional free text field, “Location”. Only an administrator can define events (and their dates). The administrator can click a cell in the event panel part of the activity view, where they can add diary events via the panel shown in FIG. 9.

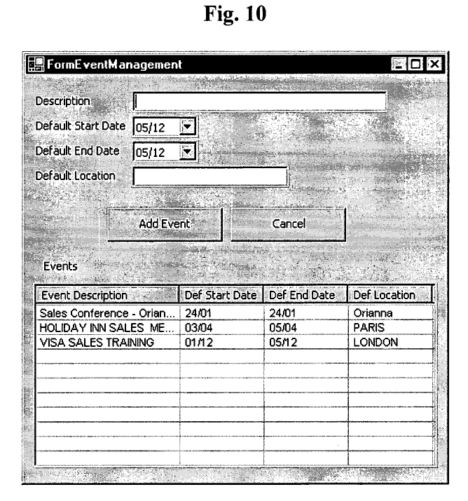

To add an event which does not already have a description, the administrator can click the “Add Event” button to the right of the drop down, and the form shown in FIG. 10 will be invoked, which will allow them to add event headings together with default start and end dates, and default location, if useful

Activities—Calendar View

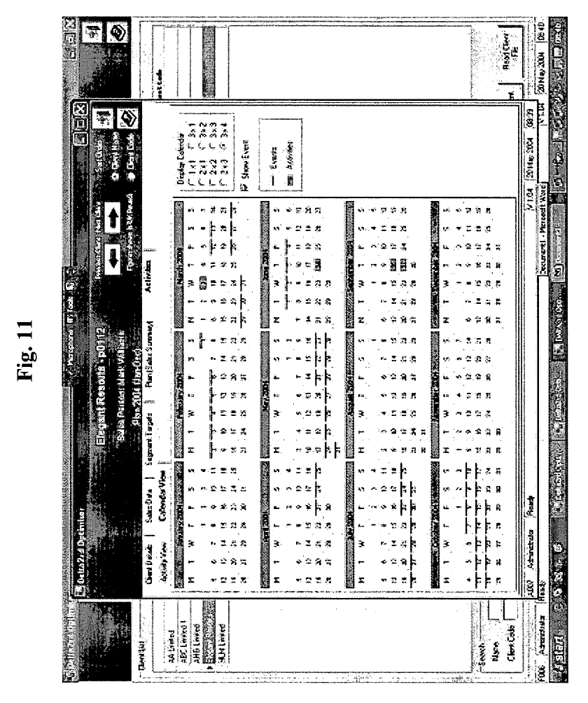

The calendar view tab as shown in FIG. 11 is simply a representation of activity and event information, depicted via the familiar calendar paradigm. The system will allow several calendar “resolutions”. The figure shows a small resolution, with an entire year on one page, useful to get an overview.

The operator can add activities using the calendar view should they so desire, by clicking on the relevant day. The Activity Add pop-up appears automatically. (Events can only be added via the “Adding Events” process described earlier, which relates to the event panel on the Activity View)

Data Entry

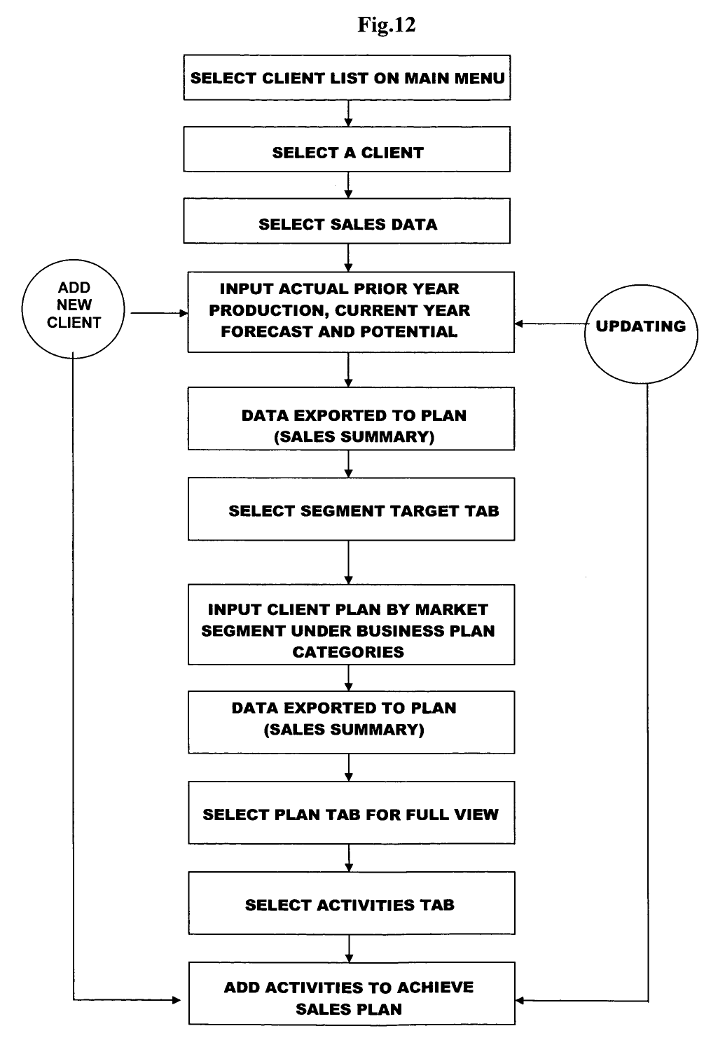

FIG. 12 shows a flow diagram for data entry by a salesperson using a method and system according to one embodiment of the present invention. The data entry procedure outlined below may be for key clients only, or for all clients. The flow diagram assumes that the system is set up (for example with the database held on a server and an application running on a PC) to include client details, but does not yet hold sales data (or sufficient sales data). The reader should note that when the system has been in operation for over a year, data such as actual prior year production (or revenue) will be available as explained below in the rollover section.

Once a client has been selected, sales figures (rooms, revenue and cover data) of the prior year, the current year forecast and the potential are entered by the salesperson, perhaps after discussion and agreement with the client. This data is exported to the plan and the salesperson proceeds to the specific segment targeting in the segment target screen. These segments should match those in the business plan. Once this specific segment plan has been finalised, this data too is exported to the plan (sales summary). Once all the information is available on the system, the salesperson can plan activities and marketing initiatives to reach the plan figures, taking into account the budget in the business plan and using the activities screens.

Although the flow diagram represents a simple sequential data entry, users may prefer to review results and then modify the plan. As shown by the updating bubble, updating (including new client addition) can be at any stage of the process from the first data input. It need not follow the strict sequence shown in the figure. For example, the user might just change the forecast and then add activities.

Typically, there will be updating over a number of months, including, for example, updating of the forecast to give a greater certainly as actual figures for each month emerge and re-arrangement of the client plan by specific market segment. It may be that further information would also lead the potential to be amended.

Once the sales team is happy to commit to the plan (usually after a final budget is set out in the business plan) the figures can be locked by a administrator so that no further change is possible.

Planning Years

Several phrases that relate to time frames have been discussed. These are defined in the table below along with how the data is rearranged for the transition between successive financial years. Imagine we are currently in 2003—this year is the “Current” year (which is also known as the “Base year”).

| | | | What happens during Roll- |
|---|---|---|---|
| Term | Year | Comments/Rules | over |
| Actual Last | 2002 | | These figures are wiped, then |
| Year | | | inherited from “Forecast Year” |
| Forecast | 2003 | | Copied into actual last year, and |
| Year | | | replaced with Plan year data |
| Current | 2003 | This is NEVER editable by the | On rollover, the value of this |
| Plan Year | | user - it is only ever read-only | data is wiped, and it then |
| | | and can't be changed by over- | inherits the values from “Plan |
| | | keying | Year” (i.e. - there is no attempt |
| | | | to roll it back into a “Last years |
| | | | plan” picture). This data is not |
| | | | displayed on screen in the |
| | | | current implementation. |
| Plan Year | 2004 | The plan year will automatically | This (plan) data gets transferred |
| | | appear on all screens/reports as a | into two areas |
| | | visual reference | Forecast Year |
| | | THIS is the category which is | Current Plan Year |
| | | actually made up of “low-level” | |
| | | market segments | |
| Potential | 2004 | This is an abstract representation | Nothing happens to this - it is |
| | | of the maximum possible potential | preserved, and is assumed to |
| | | that a client has. It is un-realistic | be “static” from the point of view |
| | | to expect that the sales office can | of planning. |
| | | win ALL of that business of | Manual update |
| | | course, however, to see the basic | |
| | | size of the clients potential helps | |
| | | the planning process | |

The reader will notice that the table above holds “Current Plan Year” and “Plan Year”. “Plan Year” is really the pivotal “focal point” of sales staff entering their planning figures, and is arguably the result of all other elements. Plan year may be extended by the supplier to cover 2 plan years item if wished.

“Current Plan Year” is actually just a reference of the “plan” which was arrived at in the last year of planning. It is called current year plan because plan is always for the upcoming next year. Imagine we are currently in 2003. The Plan year that the sales team is actively planning for is 2004. The “Current plan year” is the plan that relates to 2003 (i.e. the year that is already partially complete).

The current plan year essentially represents a non-editable (locked) copy of the plan from the last planning cycle, and allows for better decision making. The reader will note that, upon rollover, the “Plan Year” data is copied into both Forecast Year and Current Plan Year. This is logical, because the Forecast Year can be edited, and once any edits are made, it is still useful to have the reference of the plan that was done in the last cycle.

Locking Data

The system has a facility allowing the sales persons and administrator to lock the data. This needs to happen at two levels, because each sales person will lock their own set of data, i.e. data which relates to all of their clients. (i.e. ones which are linked to them via the sales person link on the client record). Only when all sales-persons have locked their data will the administrator be able to lock the entire system.

It is worth differentiating these two steps.

| | |
|---|---|
| Sales Person Lock | The administrator can change |
| | data, which was locked by the |
| | sales person. |
| Sales Team Lock | The Sales Centre will reach a point |
| | where all sales persons (and |
| | sales manager), are happy with |
| | the data they have entered, and |
| | in essence they “commit” the |
| | figures, and accept that they cannot |
| | make any more changes. |

Locking is a separate concept to rollover. Locking happens when the sales centre are ready to “commit” their figures. Regardless of the eventual consolidation mechanism figures could only ever be consolidated upwards within the Hotel Hierarchy following the “Sales Team Lock” process.

Once a data set is locked, the password of the “owner” of that data set will have their privileges changed so that they cannot alter any of the underlying data within their “scope”. Only an administrator will be able to issue a second password which will enable the user to make further edits or additions.

User Profile

Each user on the system has their own “Profile”, where they can see information about themselves, and express certain preferences.

| Field | Comments |
|---|---|
| Username | |
| Password | |
| Automatically Show | If this is ticked, then help “pop-ups” |
| Help Pop-ups | will always automatically |
| | open-up when the user |
| | goes into a new screen |
| | Default to ticked [✓] |
| Active Y/N | A flag, which is used to illustrate |
| | whether, the user is active (or |
| | obsolete). |

There is a screen to manage these users (accessible to the administrator).

Additional Data specifically held for a sales person is noted in the table below:

| Field | Comments |
|---|---|
| Number of suspects | Says how many suspects the |
| not held on Sales | salesperson knows about who don't |
| Optimiser | have records on sales optimiser. |
| Active Y/N | A flag, used to ensure we do |
| | not include the above number for |
| | salespeople who have left, but |
| | who might still be on the system. |
| | The administrator would need to |
| | change this for people who had |
| | left. |
| Initials | (Shown on report). Can be |
| | three characters. |

User Permissions

The system utilizes the concept of user groups, which is the most flexible way of implementing user permission rights. Essentially, each user on the system will belong to a specific user group.

Hard-Coded Roles (to Ensure Data Privileges)

To ensure that system scope rules are enforceable, each user on the system will need to fit into one of these three roles: Administrator; Sales Management; or Standard User.

It is possible to set up user groups with names other than those above, but each user group must be defined as having one of the above three roles. Each user group inherently has access (or not), to certain system functions. The Administrator user group has access to all system functions, and the Standard User group has access only to the core client, planning, reporting and diagnostics.

The Currency Phrase

The system never displays any currency symbols such as “£, $ etc” next to individual numbers. It requires a currency “Phrase” which appears on all reports where currency is shown, and on the “Header Panel” (see elsewhere). The currency phrase has a 15 character value (examples shown below)

“Figures shown in UK Pounds”

“Figures shown in Euros”

Although the preferred embodiments of the present invention have been disclosed for illustrative purposes, those skilled in the art will appreciate that various modifications additions and substitutions are possible, without departing from the scope and spirit of the invention as disclosed in the accompanying claims.

1. A computerised system for planning sales to clients in the hospitality, travel and leisure industries, by a sales team of at least one salesperson, comprising database software enabling
input and display of client data for each client; allocation of client data for each client to a responsible salesperson; and input and display of sales planning data for each client according to an overall business plan so that each salesperson can apportion sales time to each client according to the business plan.

2. A computerised system according to claim 1 wherein a calendar is provided which is specific to each client for the sales person to input and display sales time apportioned.

3. A computerised system according to claim 1 wherein the planning data includes sales figures by financial year, specifically for the present financial year, the last financial year and planned sales figures for the next financial year.

4. A computerised system according to claim 1, wherein the planning data includes sales figures indicating the complete potential of the client per year in the competitive set of the business to indicate the client size and for comparison purposes.

5. A computerised system according to claim 1, wherein the database software enables free input of at least some planning data and automatic calculation of totals and/or variances to allow the salesperson to explore planning scenarios.

6. A computerised system according to claim 1, wherein the planning data includes sales figures expressed in terms of revenue and in room nights for accommodation, the system providing automatic calculation and display of the average room rate (ARR, revenue divided by room nights) and/or includes sales figures in terms of number of covers and catering revenue, the system providing automatic calculation and display of the average check (average covering revenue per cover).

7. A computerised system according to claim 1, wherein the planning data is subdivided into general market segments, such as individual rooms, group and crew rooms and covers, these general market segment figures being summed automatically by the system.

8. A computerised system according to claim 1, wherein at least some of the planning data is subdivided into specific market-segments corresponding to those of the business plan, so that direct comparison between the budget allocated to the specific segment in the business plan and planned sales is possible.

9. A computerised system according to claim 1, wherein a calendar is provided which is specific to each client and wherein calendar data is entered under one of two main headings: preset events; and activities planned by the sales team with reference to the planning data and business plan.

10. A computerised system according to claim 1, wherein the system holds client data including the responsible salesperson, the client's name and contact details, any account/client code specific for the client, and a list of contact persons within the client organisation.

11. A computerised system according to claim 1, wherein the client data includes a client priority level for each client according to the revenue generated by the client allocated by the sales term and chosen from “key client”, “key prospect”, “suspect” and/or “niche client” and/or other client priority levels.

12. A computerised system according to claim 1, wherein the database software has a user interface including a client data screen for display and input of the responsible salesperson, the client's name and contact details, any account/client code specified for the client, and a list of contact persons within the client organisation as well as a client priority level.

13. A computerised system according to claim 1, wherein the database software has a user interface including a sales data screen for input and display of client potential, actual sales figures for last year and forecast for this year, wherein the displayed data may be exported to other screens.

14. A computerised system according to claim 13, wherein the sales data screen allows input and display of planning data for each year by general market segments of individual rooms, group & crew rooms and covers as well as calculation and display of total rooms, ARR, average check and total (rooms and catering) revenue.

15. A computerised system according to claim 1, wherein the database software has a user interface including a segment targets screen for input and display of revenue data according to specific market segment of the business plan and automatic calculation and display of sub-totals and/or variances corresponding to general market segments, wherein the displayed data may be exported to the appropriate general market segments for the next year.

16. A computerised system according to claim 1, wherein the database software has a user interface including: a sales summary screen for display of the client potential, actual sales figures for last year, forecast for this year and plan for next year using figures input into and calculated from others screens.

17. A computerised system according to claim 1, wherein the database software has a user interface including a sales summary screen and/or sales data screen displaying a table with sub-tables for each financial year required, each sub-table being split by general market segment into columns wherein further columns are provided for average room rate (ARR), average check and totals.

18. A computerised system according to claim 17, wherein the sub-table for each financial year is shown as a row pair giving room nights and revenue (and number of covers and revenue) where appropriate, and divided into columns by general market segment and further columns.

19. A computerised system according to claim 1, wherein the database software has a user interface including a calendar screen holding preset events and activities planned by the sales team.

20. A computerised system according to claim 1, wherein the database software has a user interface including a calendar displayed in matrix form in an activities screen, being a table listing activities or events in rows, the months being displayed in columns across the screen and the entry in each cell giving the date in the month.

21. A computerised method for planning sales to clients in the hospitality, travel and leisure industries, by a sales team of at least one salesperson comprising the following method steps:
input and display of client data for each client; allocation of client data for each client to a responsible salesperson; input and display of sales planning data for each client according to an overall business plan and individual apportioning of a salesperson's sales time to clients according to the business plan.

22. A computerised method according to claim 21, further comprising the step of entering sales time apportioned according to the business plan into a calendar in the form of planned activities.

23. A computerised method according to claim 21, wherein past sales figures are input for general market segments; planned sales figures for the next year are input for specific market segments and consolidated automatically to the general market segments; and then the past and plan figures are compared.

24. A computerised method according to claim 21, wherein sub-totals and totals are automatically calculated from the salesperson's input of planning data and the salesperson can explore different scenarios by adjusting input to arrive at a final plan.

25. A computer-readable medium or downloadable file comprising database software, which when installed on a server and PC provides a computerised system for planning sales to clients in the hospitality, travel and leisure industries, by a sales team of at least one salesperson, comprising database software enabling input and display of client data for each client; allocation of client data for each client to a responsible salesperson; and input and display of sales planning data for each client according to an overall business plan so that each salesperson can apportion sales time to each client according to the business plan.

26. A computerised system for planning sales to clients in the hospitality and leisure industries, by a sales team of at least one salesperson, comprising database software enabling input and display of client data for each client; allocation of client data for each client to a unique salesperson; input and display of sales planning data in terms of past and future sales figures for each client; and input and display of activities for the salesperson to achieve the future sales figures.

27. A computerised method for sales to clients in the hospitality, travel and leisure industries by a sales team of at least one salesperson comprising the following method steps; input and display of client data for each client; allocation of client data for each client to a unique salesperson; input and display of sales planning data in terms of past and future sales figures for each client; and input and display of activities for the salesperson to achieve the future sales figures.
